(19) United States
(12) Patent Application Publication
(10) Pub. No.: US 2022/0219576 A1
(43) Pub. Date: Jul. 14, 2022

(54) RECLINER SHAFT ASSEMBLY FOR VEHICLE AND MANUFACTURING METHOD THEREFOR

(71) Applicant: Kuktae SUNG, Dangjin-si, Chungcheongnam-do (KR)

(72) Inventor: Kuktae SUNG, Dangjin-si, Chungcheongnam-do (KR)

(21) Appl. No.: 17/609,974

(22) PCT Filed: Jul. 10, 2020
(86) PCT No.: PCT/KR2020/009120

§ 371 Date: Nov. 9, 2021

(30) Foreign Application Priority Data
Jul. 10, 2019 (KR) 10-2019-0083051

(51) Int. Cl. B60N 2/22; B60N 2/20

(52) U.S. Cl. CPC B60N 2/22; F16C 2226/80; B60N 2205/50; B60N 2/20

(57) ABSTRACT

A method for manufacturing a recliner shaft assembly for a vehicle includes the steps of: preparing a hollow shaft and a recliner lever; forming a engagement portion on one side of the hollow shaft; inserting one end of the hollow shaft into a through hole of the recliner lever such that the engagement portion is caught inside the through hole; expanding one end of the hollow shaft protruding outward through the through hole to support the recliner lever from the outside of the through hole.

### TECHNICAL FIELD

The present invention relates to a recliner shaft assembly for a vehicle and a method of manufacturing the same, and more particularly to a recliner shaft assembly for a vehicle, manufactured without a separate welding process, and a method of manufacturing the same.

### BACKGROUND ART

In general, a seat recliner device includes a fixed frame installed at a side of a seat cushion, and a rotating frame installed at a side of a seat back rotatably with respect to the fixed frame, and a recliner is installed between the fixed frame and the rotating frame to adjust a rotation angle of the rotating frame with respect to the fixed frame.

In this case, the recliner has one side coupled to a fixed frame and the other side coupled to the rotating frame and operates to lock or unlock relative rotation between the two sides according to an internal mechanism. This operation may be performed through a rotation operation of a recliner shaft, and in this case, a user may rotate the recliner shaft by manipulating a recliner lever provided at one side of the seat.

To this end, a through hole is formed at one side of the recliner lever to make one end of the recliner shaft be inserted thereinto. One end of the recliner shaft, inserted into the through hole of the recliner lever, is integrally welded with the recliner lever along a circumference of the through hole.

However, as such, when the recliner lever and the recliner shaft are coupled via welding, an internal structure of the recliner shaft may be changed due to heat applied during welding, and accordingly, there is a risk of deformation such as distortion in the recliner shaft, deterioration of durability and rigidity due to change in physical properties, and damage to a welded part.

### DISCLOSURE OF THE INVENTION

### Technical Problem

Therefore, the present invention has been made in view of the above problems, and it is an object of the present invention to provide a recliner shaft assembly for a vehicle in which a recliner lever and a recliner shaft are integrally coupled without a separate welding process.

It is another object of the present invention to provide a recliner shaft assembly for a vehicle by integrally coupling a recliner lever and a recliner shaft via press processing.

### Solution to Problem

Therefore, the present invention provides a method of manufacturing a recliner shaft assembly for a vehicle, including preparing a hollow shaft and a recliner lever, forming a flange on one side of the hollow shaft, inserting one end of the hollow shaft into a through hole of the recliner lever to allow the flange to be caught by an internal side of the through hole; and expanding one end of the hollow shaft that protrudes outward through the through hole to support the hollow shaft by an external side of the through hole.

According to an aspect of the present invention, the flange may be formed by performing pipe expansion on one side of the hollow shaft.

According to another aspect of the present invention, the flange may be formed by pressing one side of the hollow shaft.

According to another aspect of the present invention, an extension may be formed by performing pipe expansion on one end of the hollow shaft, and the extension may be tightly supported by the external side of the through hole.

According to another aspect of the present invention, the method may further include coupling a first washer to the hollow shaft to be interposed between the recliner lever and the flange.

According to another aspect of the present invention, the method may further include coupling a second washer to one end of the hollow shaft protruding out of the through hole before one end of the hollow shaft is expanded.

The present invention also provides a recliner shaft assembly for a vehicle, including a recliner lever having one side in which a through hole is formed, and a hollow shaft having one side inserted into the through hole, wherein the hollow shaft includes a flange that protrudes on an outer surface to be caught by an internal side of the through hole.

According to an aspect of the present invention, the hollow shaft may further include an extension that is expanded at one end thereof to be caught by an external side of the through hole.

According to another aspect of the present invention, the extension may be formed at one end of the hollow shaft via pipe expansion of the hollow shaft.

According to another aspect of the present invention, the flange may be formed via pipe expansion of the hollow shaft.

According to another aspect of the present invention, the flange may be formed by pressing and processing one side of the hollow shaft.

According to another aspect of the present invention, the flange may be formed by pressing one side of a spline protrusion of the hollow shaft.

According to another aspect of the present invention, the recliner shaft assembly may further include a first washer interposed between the flange and the recliner lever.

According to another aspect of the present invention, the recliner shaft assembly may further include a second washer interposed between the extension and the recliner lever.

### Effect of the Invention

When a method of manufacturing a recliner shaft assembly for a vehicle according to the present invention is used, a recliner shaft assembly for a vehicle in which a recliner lever and a recliner shaft are integrally coupled may be manufactured without a separate welding process.

When a method of manufacturing a recliner shaft assembly for a vehicle according to the present invention is used, it may be possible to prevent defects such as deformation or damage such as distortion, or deterioration of durability and rigidity, caused due to heat of conventional welding.

### BRIEF DESCRIPTION OF DRAWINGS

FIG. 1 is a perspective view of a recliner shaft assembly according to an embodiment of the present invention.

FIG. 2 is a cross-sectional view of FIG. 1.

FIG. 3 is a flowchart of a method of manufacturing a recliner shaft assembly according to an embodiment of the present invention.

FIG. 4 is a manufacturing process diagram of a recliner shaft assembly according to an embodiment of the present invention.

FIG. 5 is a schematic diagram showing a process of forming a flange according to an embodiment of the present invention.

FIG. 6 is a perspective view of a recliner shaft assembly according to another embodiment of the present invention.

FIG. 7 is a cross-sectional view of FIG. 6.

FIG. 8 is a schematic diagram showing a process of forming a flange according to another embodiment of the present invention.

### DETAILED DESCRIPTION OF THE INVENTION

Hereinafter, an embodiment of the present invention will be described in detail with reference to the accompanying drawings. However, the embodiments described below are merely for explaining in detail enough to be easily implemented by one of ordinary skill in the art to which the present invention pertains, which does not limit the scope of the present invention. In describing various embodiments of the present invention, the same reference numerals will be used for components having the same components.

### Embodiment

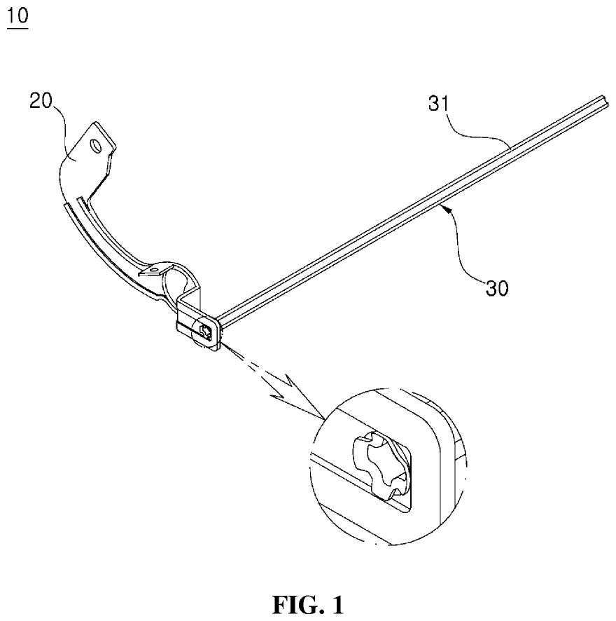

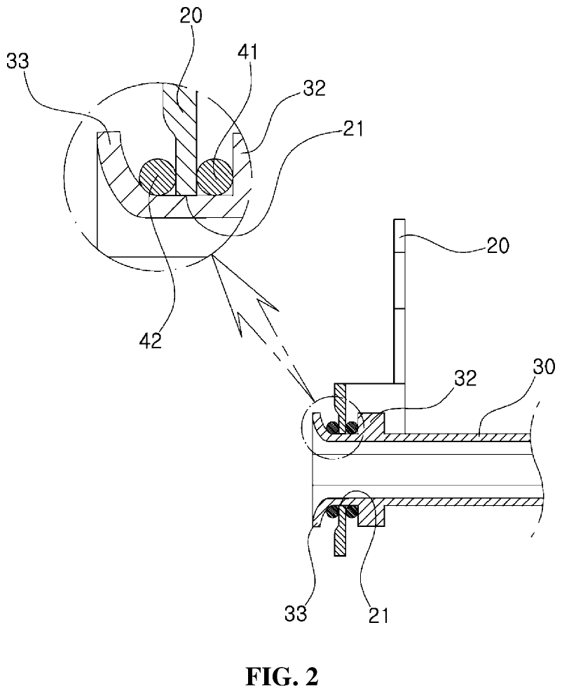

FIG. 1 is a perspective view of a recliner shaft assembly according to an embodiment of the present invention, and FIG. 2 is a cross-sectional view of FIG. 1.

As shown in FIGS. 1 and 2, a recliner shaft assembly 10 according to an embodiment of the present invention may include a recliner lever 20 and a hollow shaft 30.

A through hole 21 may be formed at one side of the recliner lever 20, and one end of the hollow shaft 30 may be inserted into and coupled to the through hole 21. In this case, a sectional shape of the hollow shaft 30 may be variously selected as necessary.

For example, a plurality of spline protrusions 31 spaced apart from each other by a predetermined interval in a circumferential direction may protrude a long way in a longitudinal direction of the hollow shaft 30 on an outer surface of a body of the hollow shaft 30 to make the hollow shaft 30 be splined to the through hole 21 of the recliner lever 20 and rotate integrally.

In this case, a flange 32 with an expanded width may be formed to protrude on one side of a spline protrusion 31. The flange 32 may be spaced apart inward from one end of the hollow shaft 30 and may protrude from the spline protrusion 31 in a direction perpendicular to an axis of the hollow shaft 30, i.e., outward in a radial direction of the hollow shaft 30.

For example, the flange 32 may protrude by pressing one side of the spline protrusion 31. In this case, while being pressed flat, one side of the spline protrusion 31 may spread outward in a radial direction, and the flange 32 may protrude. However, this is only an embodiment of the present invention, and needless to say, the flange 32 may be formed on the outer surface of the hollow shaft 30 by selecting various methods as necessary, such as pipe expansion.

The width of the flange 32 may be larger than the diameter of the through hole 21, and accordingly, when the hollow shaft 30 is inserted into the through hole 21 of the recliner lever 20, the flange 32 of the hollow shaft 30 may be caught on an inner edge of the through hole 21 to be prevented from being separated therefrom.

An extension 33 with an expanded width may be formed on one side of the hollow shaft 30 inserted into the through hole 21 of the recliner lever 20, and for example, pipe expansion may be performed on one end of the hollow shaft 30 to form the extension 33. As the extension 33 formed as such may be caught by an outer edge of the through hole 21, the hollow shaft 30 may be prevented from being separated from the recliner lever 20.

That is, across the recliner lever 20, the flange 32 of the hollow shaft 30 may be caught by the inner edge of the through hole 21, and the extension 33 of the hollow shaft 30 may be caught by the outer edge of the through hole 21, and thus the hollow shaft 30 may be fixedly coupled to the through hole 21 of the recliner lever 20.

In this case, a first washer 41 may be interposed between the recliner lever 20 and the flange 32, and a second washer 42 may be interposed between the extension 33 and the recliner lever 20 to fixedly couple the hollow shaft 30 to the recliner lever 20 by the flange 32 and the extension 33. Needless to say, any one of the first washer 41 and the second washer 42 may be interposed.

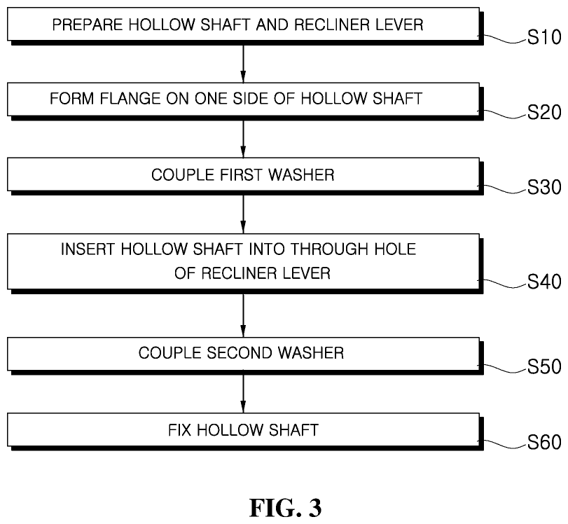

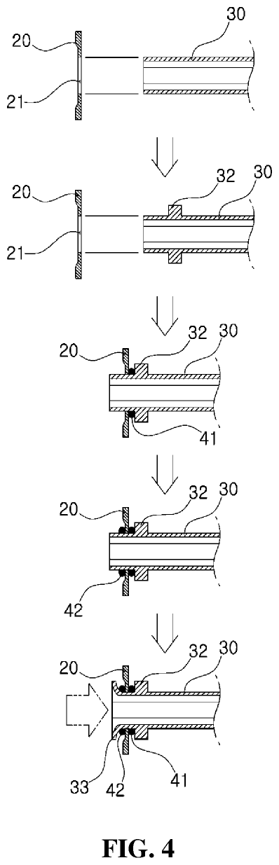

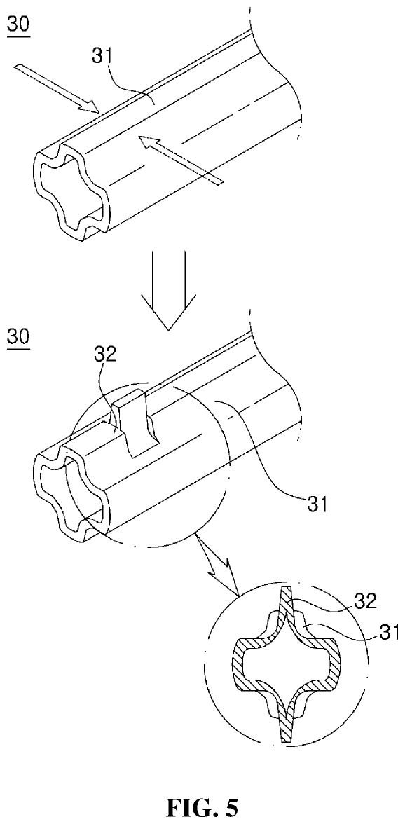

FIG. 3 is a flowchart of a method of manufacturing a recliner shaft assembly according to an embodiment of the present invention, FIG. 4 is a manufacturing process diagram of a recliner shaft assembly according to an embodiment of the present invention, and FIG. 5 is a schematic diagram showing a process of forming a flange according to an embodiment of the present invention.

Hereinafter, with reference to FIGS. 3 to 5, a method of manufacturing a recliner shaft assembly according to an embodiment of the present invention will be sequentially described in detail.

Prepare Hollow Shaft and Recliner Lever (S10):

The recliner shaft assembly 10 for a vehicle according to an embodiment of the present invention may include the recliner lever 20, and the hollow shaft 30 with one end fixedly inserted into the through hole 21 of the recliner lever 20.

Thus, first, it may be necessary to prepare each of the hollow shaft 30 and the recliner lever 20.

In this case, a sectional shape of the hollow shaft 30 may be variously selected as necessary, and for example, the hollow shaft 30 may be configured in such a way that the plurality of spline protrusions 31 protrudes along a circumference of the outer surface of the body.

In order to couple the recliner lever 20 and the hollow shaft 30, the through hole 21 may be formed at one side of the recliner lever 20 to insert one end of the hollow shaft 30 thereinto, and the through hole 21 may be formed with a shape corresponding to a sectional shape of the hollow shaft 30. That is, a plurality of spline grooves (not shown) may be formed along an internal circumference of the through hole 21 to correspond to the spline protrusions 31 of the hollow shaft 30.

Form Flange at One Side of Hollow Shaft (S20):

The flange 32 may protrude at one side of the hollow shaft 30. For example, as shown in FIG. 5, the flange 32 may be formed by pressing one side of the hollow shaft 30, that is, one side of the spline protrusion 31.

Couple First Washer (S30):

The first washer 41 may be coupled to one end of the hollow shaft 30. The first washer 41 inserted into the hollow shaft 30 may be caught by an external side of the flange 32, that is, one end of the hollow shaft 30. This operation may also be omitted as necessary.

Insert Hollow Shaft into Through Hole of Recliner Lever (S40):

One end of the hollow shaft 30 may be inserted into the through hole 21 of the recliner lever 20. In this case, the first washer 41 may be caught by an internal side of the through hole 21 and may be tightly supported. That is, the first washer 41 may be interposed between the recliner lever 20 and the flange 32.

When the first washer 41 is omitted, the hollow shaft 30 may be inserted into the through hole 21 until the flange 32 of the hollow shaft 30 is caught by the internal side of the through hole 21 and is tightly supported.

Couple Second Washer (S50):

One end of the hollow shaft 30 may protrude in an outward direction of the recliner lever 20 through the through hole 21 of the recliner lever 20, and the second washer 42 may be coupled to one end of the hollow shaft 30 that protrudes as such. The second washer 42 inserted as such may be adhered to an outer edge of the through hole 21. As necessary, this operation may also be omitted.

Fix Hollow Shaft (S60):

The hollow shaft 30 may be fixed to the through hole 21 of the recliner lever 20. To this end, an external circumference of the hollow shaft 30 that protrudes in an outward direction of the recliner lever 20 may be expanded by pressing one end of the hollow shaft 30 and may be tightly supported by an external side of the second washer 42. When the second washer 42 is not present, the hollow shaft 30 may be tightly supported by the outer edge of the through hole 21.

For example, pipe expansion may be formed on one end of the hollow shaft 30 that protrudes in an outward direction of the recliner lever 20 to form the extension 33, thereby preventing the hollow shaft 30 from being separated from the through hole 21. In another example, it may also be possible to form the extension 33 at an end of the hollow shaft 30 by hitting one end of the hollow shaft 30 toward the recliner lever 20 with a press.

In this case, the hollow shaft 30 may be configured in such a way that the extension 33 is tightly supported by an external side of the through hole 21 across the second washer 42 and the flange 32 is tightly supported by an internal side of the through hole 21 across the first washer 41, and accordingly, the state in which the hollow shaft 30 is fixedly coupled to the through hole 21 of the recliner lever 20 may be maintained. Here, as described above, any one or both of the first washer 41 and the second washer 42 may be omitted.

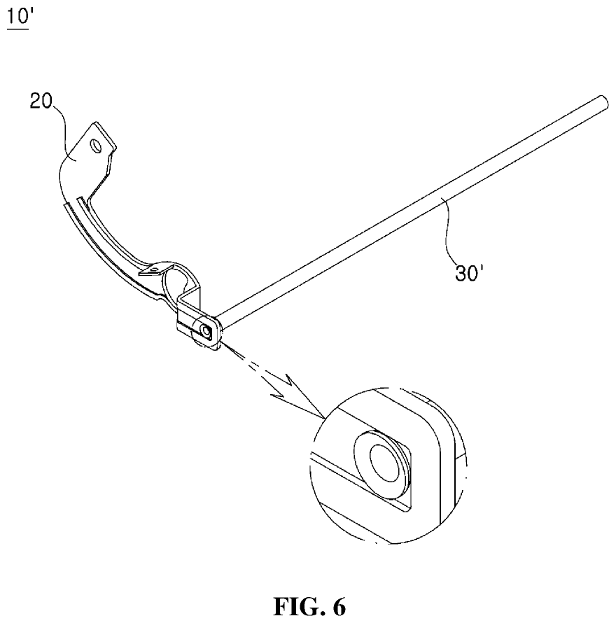

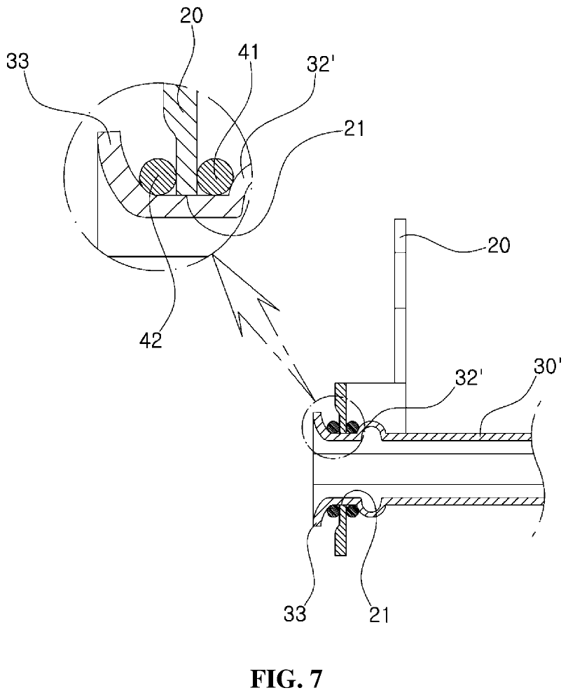

FIG. 6 is a perspective view of a recliner shaft assembly according to another embodiment of the present invention, and FIG. 7 is a cross-sectional view of FIG. 6.

As shown in FIGS. 6 and 7, a hollow shaft 30′ may also have a circular sectional shape. Pipe expansion may be performed on one side of the hollow shaft 30′ having a circular or polygonal section to form a flange 32′, and in another example, the flange 32′ having an annular shape may also protrude by pressing one side of the hollow shaft 30′ during a canning operation of the hollow shaft 30′.

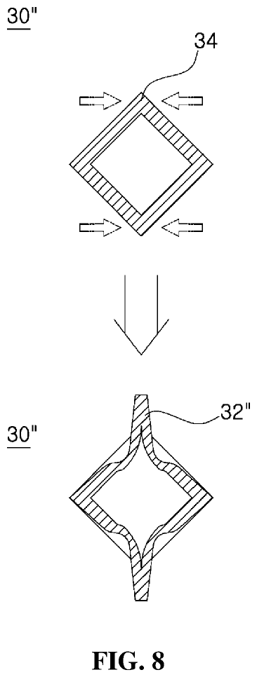

FIG. 8 is a schematic diagram showing a process of forming a flange according to another embodiment of the present invention. In the case of a hollow shaft 30″ having a polygonal sectional shape, a flange 32″ with an expanded width may also be formed at one side of an outer surface of the hollow shaft 30″ by pressing a corner 34 having a polygonal section flat. The pressed flange 32″ may be caught by an internal side of the through hole 21 to prevent separation of the hollow shaft 30″ when the hollow shaft 30″ is inserted into the through hole 21 of the recliner lever 20.

Although the embodiments of the present invention have been described above, it is understood that those of ordinary skill in the art to which the present invention pertains may make various modifications without departing from the claims of the present invention.

### INDUSTRIAL APPLICABILITY

When a method of manufacturing a recliner shaft assembly for a vehicle according to the present invention is used, a recliner shaft assembly for a vehicle may be manufactured without a separate welding process.

When a method of manufacturing a recliner shaft assembly for a vehicle according to the present invention is used, it may be possible to prevent defects such as deformation or damage such as distortion, or deterioration of durability and rigidity, caused due to heat of conventional welding.

1. A method of manufacturing a recliner shaft assembly for a vehicle, the method comprising:
preparing a hollow shaft and a recliner lever;
forming a flange on one side of the hollow shaft;
inserting one end of the hollow shaft into a through hole of the recliner lever to allow the flange to be caught by an internal side of the through hole; and
expanding one end of the hollow shaft that protrudes outward through the through hole to support the hollow shaft by an external side of the through hole.

2. The method according to claim 1, wherein the flange is formed by performing pipe expansion on one side of the hollow shaft.

3. The method according to claim 1, wherein the flange is formed by pressing one side of the hollow shaft.

4. The method according to claim 1, wherein an extension is formed by performing pipe expansion on one end of the hollow shaft, and the extension is tightly supported by the external side of the through hole.

5. The method according to claim 1, further comprising:
coupling a first washer to the hollow shaft to be interposed between the recliner lever and the flange.

6. The method of claim 1, further comprising:
coupling a second washer to one end of the hollow shaft protruding out of the through hole before one end of the hollow shaft is expanded.

7. A recliner shaft assembly for a vehicle, comprising:
a recliner lever having one side in which a through hole is formed; and
a hollow shaft having one side inserted into the through hole,
wherein the hollow shaft includes a flange that protrudes on an outer surface to be caught by an internal side of the through hole.

8. The recliner shaft assembly according to claim 7, wherein the hollow shaft further includes an extension that is expanded at one end thereof to be caught by an external side of the through hole.

9. The recliner shaft assembly according to claim 8, wherein the extension is formed at one end of the hollow shaft via pipe expansion of the hollow shaft.

10. The recliner shaft assembly according to claim 7, wherein the flange is formed via pipe expansion of the hollow shaft.

11. The recliner shaft assembly according to claim 7, wherein the flange is formed by pressing and processing one side of the hollow shaft.

12. The recliner shaft assembly according to claim 11, wherein the flange is formed by pressing one side of a spline protrusion of the hollow shaft.

13. The recliner shaft assembly according to claim 7, further comprising:
a first washer interposed between the flange and the recliner lever.

14. The recliner shaft assembly according to claim 8, further comprising:
a second washer interposed between the extension and the recliner lever.
